(19) United States
(12) Patent Application Publication
(10) Pub. No.: US 2014/0184419 A1
(43) Pub. Date: Jul. 3, 2014

(54) Alarm communication recovery system and method

(71) Applicant: Multicom Systems Pty Ltd, Wetherill Park (AU)

(72) Inventor: Glenn Gary Smith, Wetherill Park (AU)

(73) Assignee: Multicom Systems Pty Ltd, Wetherill Park (AU)

(21) Appl. No.: 14/138,060

(22) Filed: Dec. 21, 2013

Related U.S. Application Data
(60) Provisional application No. 61/747,311, filed on Dec. 30, 2012.

(51) Int. Cl. G08B 29/18

(52) U.S. Cl. CPC G08B 29/18
USPC 340/693.1

(57) ABSTRACT

An alarm communicator system has the capability to restore a Wide Area Network (WAN) connection to a remote alarm monitoring center. The system includes an alarm WAN communicator for communicating an alarm signal to a WAN gateway; a WAN outage detector for detecting a WAN outage condition; a power interruption signal transmitter connected to the alarm WAN communicator; a power interrupter unit connected between a WAN gateway power source and the gateway; and a power interruption signal receiver connected to the power interrupter unit. The system can transmit a power interruption signal through the power interruption signal transmitter after detection of the WAN outage condition. The power interrupter unit disconnects and then reconnects the power supplied from the power source to the gateway after receipt of the power interruption signal so as to cause the WAN gateway to power down and restart after the power supply is reconnected.

### CROSS-REFERENCE TO RELATED APPLICATIONS

This application claims the benefit of U.S. Provisional Application No. 61/747,311, filed 30 Dec. 2012, which is hereby incorporated by reference herein.

### TECHNICAL FIELD

In the field of electrical communications, an alarm system which is adapted to communicate alarm signals over a Wide Area Network such as the Internet to a remote alarm monitoring center, and in particular to a method and system having the capability to restore an inoperative Wide Area Network connection.

### BACKGROUND

Standalone alarm systems are known with alarm communicators which use the public switched telephone network (PSTN) to communicate alarm signals to a remote monitoring center using a communications protocol specific for alarms such as ContactID. These may offer only a single path of communication to the remote monitoring center.

Backup systems are also known to convert PSTN alarm signals from a conventional alarm communicator to signals compatible with Internet communication via a digital communications protocol whereby an alternative path of communication to the remote monitoring center may be established. Systems which have a primary or sole Internet means of communication with the remote monitoring center are also available. The primary path of such Internet based communication is the ordinary public Internet. The primary issue of using public Internet is reliability from a number of causes:

(1) a premises Internet gateway does not always reliably connect to the Internet;

(2) networking or related equipment does not reliably maintain both internal or external network communications;

(3) recovery from communications outages or other network failures may not occur for an extended period of time;

(4) a premises Internet gateway may be at a location at the premises distant from the alarm system, limiting actions in relation to the gateway that can be taken by the alarm Wide Area Network communicator; and

(5) replacing a premises Internet gateway with a more reliable version is often not an economically viable option.

There is therefore a need to provide an improved system and method for communicating alarm signals to a remote monitoring center which uses the Internet or other Wide Area Network but is less sensitive to equipment failure.

It is an object of the current invention to overcome one or more of the above-mentioned disadvantages.

### SUMMARY OF THE INVENTION

According to a broad aspect of the invention there is provided an alarm communicator system having the capability to restore a Wide Area Network connection to a remote alarm monitoring center, the system comprising:

an alarm Wide Area Network communicator for communicating an alarm signal to a Wide Area Network gateway;

a Wide Area Network outage detector for detecting a Wide Area Network outage condition;

a power interruption signal transmitter within or operationally connected to the alarm Wide Area Network communicator;

a power interrupter unit connected between a Wide Area Network gateway power source and the gateway; and

a power interruption signal receiver within or operationally connected to the power interrupter unit; and

the system being adapted to transmit a power interruption signal through the power interruption signal transmitter after detection of the Wide Area Network outage condition; and the power interrupter unit being adapted to disconnect and then reconnect the power supplied from the power source to the gateway after receipt of the power interruption signal so as to cause the Wide Area Network gateway to power down and restart after the power supply is reconnected.

In one embodiment, the power interruption signal is a wireless signal. The wireless signal may be transmitted directly from the power interruption signal transmitter to the power interruption signal receiver, or through a network.

In one embodiment, the Wide Area Network and gateway is an Internet gateway.

In one embodiment, the outage condition is detected on the basis of detection of one or more outage events, and the outage events detectable by the detector include at least one of:

a faulty cable connection to the gateway;

a failed communications connection to the gateway; and

a failed communications connection to a remote or external network; or failure to receive an appropriate response through the gateway from the remote alarm monitoring center.

According to a second broad aspect of the invention there is provided, using the alarm communicator system of the first broad aspect of the invention, a method of restoring the Wide Area Network connection to the remote alarm monitoring center, the method comprising the steps of:

detecting the Wide Area Network outage condition using the Wide Area Network outage detector;

transmitting the power interruption signal from the alarm Wide Area Network communicator;

receiving the power interruption signal in the power interrupter unit; and

performing the disconnection of the power supply so as to cause the Wide Area Network gateway to power down and restart after the power supply is reconnected.

### BRIEF DESCRIPTION OF DRAWINGS

The FIGURE is a block diagram of the system according to an embodiment of the invention.

### DETAILED DESCRIPTION OF EMBODIMENTS

An embodiment of the current invention will now be described.

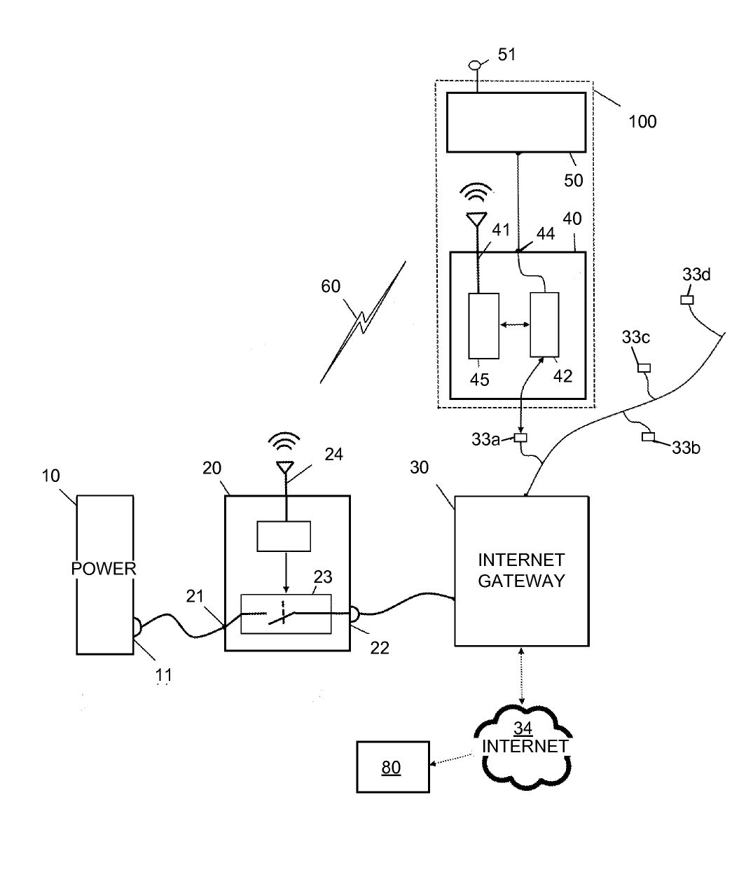

Referring first to FIG. 1, a premises power supply 10 which may be a mains or backup power supply supplies power through power plug 11 to the power interrupter unit 20. In a normal uninterrupted state, power interrupter unit 20 allows electrical power to pass from power input 21 to power outlet 22. Power interrupter unit 20 comprises power interrupter switch 23 in the form of a solid-state relay or similar and power interrupter signal receiver 24 adapted to receive a power interruption signal 60 that is wireless. Power interrupter unit 20 is programmed on receipt of power interruption signal 60 to disconnect power supply from power outlet 22 and after an effective interval (typically one to several seconds) to reconnect the power supply to power outlet 22.

The Wide Area Network gateway is in this embodiment an Internet gateway 30 serving general purposes for use by occupants of the premises which connects a local area network served through communications wall jacks 33a, 33b, 33c and 33d in different locations of the premises and/or via a wireless network to the Internet 34. Internet gateway 30 is powered from power interrupter unit 20 through power outlet 22.

In this embodiment, alarm communicator 100 is composed of an alarm tone signal communicator 50, which is a conventional PSTN tone signal communicator, connected to the alarm Wide Area Network communicator 40. PSTN signals generated on receipt of signals from alarm sensor 51 are sent from PSTN alarm communicator, the alarm tone signal communicator 50, either directly over telephone lines or to PSTN input 44 of alarm Wide Area Network communicator 40 which feeds the signal to a tone signal converter 42. Tone signal converter 42 converts the PSTN alarm signal into a protocol suitable for communicating over the Internet to the alarm monitoring center 80. Processor 45 is programmed, apart from performing its normal operations of controlling the tone signal converter 42, to perform functions of a Wide Area Network outage detector, monitoring for one or more of a set of outage events any one of which indicates an outage condition whereby communication to the remote monitoring center is prevented. The outage events detectable by the outage detector are in this embodiment:

a faulty cable connection to the gateway, detectable by monitoring voltages on the communications wall jack 33a;

a failed communications connection to the gateway, detectable by monitoring the gateway communications protocol; and

a failed communications connection to a remote or external network, or failure to receive an appropriate response through the gateway from the remote alarm monitoring center, detectable in the normal course of events in the monitoring of responses from the remote alarm monitoring center.

Upon detection of the Wide Area Network outage condition, the system of the invention attempts to solve the problem by restarting the Internet gateway 30 on the premises. Processor 45 transmits a power interruption signal through power interruption signal transmitter 41, which may be a Wi-Fi transceiver operating in peer-to-peer mode or as part of a network. Power interrupter unit 20, which is monitoring for the signal, receives the power interruption signal 60 through power interruption signal receiver 24 (which may also be a Wi-Fi transceiver), and causes power interrupter switch 23 to open, switching off the power supply to power outlet 22. This causes Internet gateway 30 to power down. After several seconds, power interrupter unit 20 is programmed (either preprogrammed or instructed by a code in the power interruption signal 60) to close power interrupter switch 23, restoring power to the power outlet 22. Internet gateway 30 then powers up, potentially solving the connection problem.

The operation of the invention may involve a number of intervening internal steps taken by alarm Wide Area Network communicator 40 that are already known in the art which are used to attempt recovery from a Wide Area Network outage condition before the gateway is finally reset according to the invention. As an example, the following scenario is provided:

processor 45 is initially detecting reliable operation connected to the alarm monitoring center with data being received and sent at 10 second intervals;

suddenly processor 45 detects that data is no longer being received from the alarm monitoring center. This is one of the outage events and triggers the Wide Area Network outage condition, but the initial response is not to attempt to power down the gateway;

as a first attempt, processor 45 resets its own LAN interface, and confirms that a local connection is re-established. Processor 45 and confirms that there is a connection with the remote monitoring center, but after one minute still no data acknowledgement can be detected from the remote monitoring center;

as a second attempt, processor 45 performs a software power down and restart of itself and alarm Wide Area Network communicator 40, but is still unable to detect any data acknowledgement from the remote monitoring center;

as a final attempt making use of the invention, processor 45 transmits a power interruption signal 60, which is coded and wireless, through the power interruption signal transmitter 41, commanding power interrupter unit 20 to disconnect power to the gateway for one second and then reconnect power; and

after the gateway reconnects to the Internet, processor 45 is able to re-establish full connection to the remote monitoring center, sending and receiving data at 10 second intervals.

In the example above, the total time taken to re-establish connection was about two minutes 30 seconds, compared with prior art systems that are unable to restart the gateway automatically that may take several hours until human intervention arrives to re-establish connection.

Almost all network outages are caused by the premises Internet connection either partially or completely failing to maintain its connection to the Internet, which can usually be solved by turning off and restarting the Internet gateway device. Consequently the invention allows automatic recovery from an unreliable Internet gateway in the majority of circumstances, without costly replacement of Internet gateway equipment.

Throughout this specification, the term “Wide Area Network” includes the Internet, but extends to any wide area network. The term “gateway” refers to any premises network equipment which is needed for the provision of gateway access on the premises to the Wide Area Network.

Persons skilled in the art will also appreciate that many variations may be made to the invention without departing from the scope of the invention.

For example, while the most convenient form of the invention involves a private wireless connection between alarm Wide Area Network communicator 40 and power interrupter unit 20, any form of connection is within the broadest scope of the invention, including wired connections, non-digital wireless transmission, and the use of a premises Wi-Fi network. Further, it is not a necessary element of the broadest aspect of the invention that the signal be a coded signal including information as to the length of power interruption, as provided in the example above.

Further still, while the example provided involves an alarm Wide Area Network communicator 40 connected to the output of an alarm tone signal communicator 50, the invention extends to any configuration of alarm communication which results in a data signal being sent over the Internet or other Wide Area Network. Also, although an example provided a processor inside the alarm Wide Area Network communicator provides the executive functions of causing the transmission of the power interruption signal 60, the broadest aspect of the invention extends to configurations whereby such decision may be in a unit operationally connected to but outside the alarm Wide Area Network communicator.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention. Further, any method steps recited in the claims are not necessarily intended to be performed temporally in the sequence written, or to be performed without pause once started, unless the context requires it.

It is to be understood that, if any prior art publication is referred to herein, such reference does not constitute an admission that the publication forms a part of the common general knowledge in the art, in Australia or any other country.

What is claimed is:

1. An alarm communicator system having capability to restore a Wide Area Network connection to a remote alarm monitoring center, the alarm communicator system comprising:
an alarm Wide Area Network communicator for communicating an alarm signal to a Wide Area Network gateway;
a Wide Area Network outage detector for detecting a Wide Area Network outage condition;
a power interruption signal transmitter within or operationally connected to the alarm Wide Area Network communicator;
a power interrupter unit connected between a Wide Area Network gateway power source and the gateway;
a power interruption signal receiver within or operationally connected to the power interrupter unit; and
the system being adapted to transmit a power interruption signal through the power interruption signal transmitter after detection of the Wide Area Network outage condition; and the power interrupter unit being adapted to disconnect and then reconnect a power supply from the power source to the gateway after receipt of the power interruption signal so as to cause the Wide Area Network gateway to power down and restart after the power supply is reconnected.

2. The alarm communicator system of claim 1, wherein the power interruption signal is a wireless signal.

3. The alarm communicator system of claim 2, wherein the wireless signal is transmitted directly from the power interruption signal transmitter to the power interruption signal receiver.

4. The alarm communicator system of claim 1, wherein the Wide Area Network and gateway is an Internet gateway.

5. The alarm communicator system of claim 1, wherein the outage condition is detected on a basis of detection of one or more outage events, and the outage events detectable by the detector is selected from the group consisting of:
a faulty cable connection to the gateway;
a failed communications connection to the gateway;
a failed communications connection to a remote or external network; and
failure to receive an appropriate response through the gateway from the remote alarm monitoring center.

6. Using the alarm communicator system of claim 1, a method of restoring the Wide Area Network connection to the remote alarm monitoring center, the method comprising the steps of:
detecting the Wide Area Network outage condition using the Wide Area Network outage detector;
transmitting the power interruption signal from the alarm Wide Area Network communicator;
receiving the power interruption signal in the power interrupter unit; and
performing the disconnection of the power supply so as to cause the Wide Area Network gateway to power down and restart after the power supply is reconnected.
